(19) United States
(12) Patent Application Publication
(10) Pub. No.: US 2026/0037454 A1
(43) Pub. Date: Feb. 5, 2026

(54) COMMUNICATION BETWEEN A COMPUTING ELEMENT OF A MEMORY DEVICE AND AN ELECTRONIC DEVICE

(71) Applicant: SK Hynix NAND Product Solutions Corp. (dba Solidigm), Rancho Cordova, CA (US)

(72) Inventors: Vincent LAZO, San Dimas, CA (US); Hermes Alexandre ALCANTARA SILVA COSTA, Mission Viejo, CA (US); Vladimir ALVES, Newport Beach, CA (US)

(21) Appl. No.: 18/791,987

(22) Filed: Aug. 1, 2024

(51) Int. Cl. G06F 13/12; G06F 13/38; G06F 13/42

(52) U.S. Cl. CPC G06F 13/128; G06F 13/387; G06F 13/4221

(57) ABSTRACT

This application is directed to creating a communication link between computing elements of memory devices and host device(s). A memory device includes an input/output data interface configured to couple to a data bus and communicate data via the data bus. A memory device further includes a data processor coupled to the input/output data interface. The data processor has a device IP address. The data processor is configured to generate first payload data having a TCP/IP packet format. The first payload data includes at least one of the device IP address of the data processor and a target IP address of a host device. The data processor is further configured to convert the first payload data to output data having a PCIe packet format. The data processor is further configured to provide the output data to the input/output data interface for communicating the output data via the data bus.

### TECHNICAL FIELD

This application relates generally to data communication in an electronic system including, but not limited to, methods, systems, and non-transitory computer-readable media for exchanging data between a computational storage device and an external electronic device in the electronic system.

### BACKGROUND

Memory is employed in a computer system to store instructions and data. The data are processed by one or more processors of the computer system according to the instructions stored in the memory. Multiple memory units are used in different portions of the computer system to serve different functions. Specifically, the computer system includes non-volatile memory that acts as secondary memory to keep data stored thereon if the computer system is decoupled from a power source. Examples of the secondary memory include, but are not limited to, hard disk drives (HDDs) and solid-state drives (SSDs). The secondary memory is coupled to, and collaborates with, an external computational device having one or more processors and specializing in data processing. The secondary memory relies on a memory controller to manage its memory space, and process read, write, and read-modify-write requests from the host device.

### SUMMARY

Various embodiments of this application are directed to communicating data between computing elements (e.g., a data processor) of a memory device and an external host device. In some embodiments, the memory device is transformed to a computational storage device (CSD) by incorporating at least one computing element (e.g., the data processor). The data processor is configured to process internal computational workloads (e.g., the data processing operations) locally on the memory device, while a memory controller of the memory device specializes in performing memory access functions and internal memory management functions. In some situations, a virtual communication link or network is established between the memory device and the external host device to enable data communication, and data is communicated in compliance with a data interface protocol (e.g., PCIe) associated with the virtual communication link or network. Further, in some embodiments, a virtual communication link or network communicatively couples a plurality of computational storage devices and a plurality of host devices to form an ecosystem of applications and services. For each of the computational storage devices transformed from the memory devices, a respective computing element operates on an operating system (e.g., Linux) on a storage side and is identified with an Internet Protocol (IP) address on the virtual link or communication network.

In some embodiments, the virtual communication link or network is established based on standard solid-state drive (SSD) protocols and associated physical and electrical connections. The virtual communication link or network may exclusively utilize Peripheral Component Interconnect Express (PCIe) infrastructure, e.g., PCIe protocols and associated features and interrupt mechanisms. The virtual communication link or network allows for transferring data packets, such as Transmission Control Protocol/Internet Protocol (TCP/IP) or User Datagram Protocol (UDP) packets, bidirectionally between computing elements of a memory device and a host device. In some embodiments, for either one of the host device and the computational storage device, a portion of a respective PCIe buffer is allocated for storing corresponding outgoing and incoming data packets. Furthermore, operation of the virtual communication link or network is independent of a storage protocol, e.g., Nonvolatile Memory Express (NVMe), thereby resulting in scalability and flexibility for data communication.

In accordance with one aspect of the application, a memory device includes an input/output data interface configured to couple to a data bus and communicate data via the data bus. The memory device further includes a data processor coupled to the input/output data interface. The data processor has a device IP address. The data processor is configured to generate first payload data having a TCP/IP packet format. The first payload data includes at least one of the device IP address of the data processor and a target IP address of a host device. The data processor is also configured to convert the first payload data to output data having a PCIe packet format. The data processor is further configured to provide the output data to the input/output data interface for communicating the output data via the data bus.

In another aspect of the application, a method is implemented to create a virtual communication link or network between computing elements. A memory device includes an input/output data interface configured to couple to a data bus and communicate data via the data bus. A memory device further includes a data processor coupled to the input/output data interface. The data processor has a device IP address. The method includes, by the data processor, generating first payload data having a TCP/IP packet format. The first payload data including at least one of the device IP address of the data processor and a target IP address of a host device. The method also includes, by the data processor, converting the first payload data to output data having a PCIe packet format. The method further includes, by the data processor, providing the output data to the input/output data interface for communicating the output data via the data bus.

In yet another aspect of the application, a memory system includes a memory controller, a processor distinct from the memory controller, and a non-volatile memory coupled to the memory controller. The memory stores instructions configured for performing any of the methods described in the above embodiments.

In yet another aspect of the application, a non-transitory computer-readable storage medium stores instructions, which when executed by a memory system cause the memory system to perform any of the methods described in the above embodiments.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a block diagram of an example system module in a typical electronic device in accordance with some embodiments.

FIG. 2 is a block diagram of a memory system of an example electronic device having one or more memory access queues, in accordance with some embodiments.

FIG. 3 is a block diagram of an example computer system that includes a memory system having an internal processing capability, in accordance with some embodiments.

FIG. 4 is a block diagram of an example computer system including a memory system that operates in compliance with a storage access and transport protocol, in accordance with some embodiments.

FIGS. 5A and 5B are block diagrams of two example electronic systems having a virtual communication link for communicating data between a memory device and a host device, in accordance with some embodiments.

FIG. 6 is a flow diagram of an example process of transmitting messages to a host device via a virtual communication link, in accordance with some embodiments.

FIG. 7 is a flow diagram of an example process of receiving messages by the computational storage device via a virtual communication link, in accordance with some embodiments.

FIG. 8 is a flow diagram of an example process of receiving messages by a host device via a virtual communication link, in accordance with some embodiments.

FIG. 9 is a flow diagram of an example process of receiving messages by a host device via a virtual communication link, in accordance with some embodiments.

FIG. 10 is a flow diagram of an example method of creating a virtual communication link or network, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

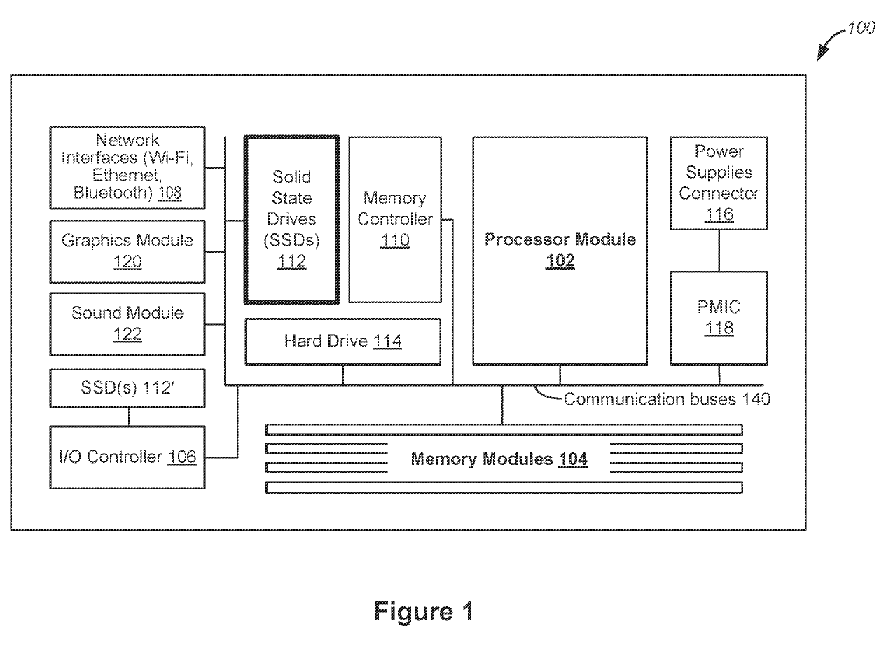

FIG. 1 is a block diagram of an example system module 100 in a typical electronic system in accordance with some embodiments. The system module 100 in this electronic system includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet and Bluetooth networks, each allowing the electronic system to exchange data with an external source, e.g., a server or another electronic system. In some embodiments, the communication buses 140 include circuitry (sometimes called a chipset) that interconnects and controls communications among various system components included in system module 100.

In some embodiments, the memory modules 104 include high-speed random-access memory (RAM), such as static random-access memory (SRAM), double data rate (DDR) dynamic random-access memory (DRAM), or other random-access solid state memory devices. In some embodiments, the memory modules 104 include non-volatile memory, such as one or more magnetic disk storage devices, optical disk storage devices, flash memory devices, or other non-volatile solid state storage devices. In some embodiments, the memory modules 104, or alternatively the non-volatile memory device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a memory controller 110, SSD(s) 112, an HDD 114, power management integrated circuit (PMIC) 118, a graphics module 120, and a sound module 122. The memory controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data storage device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively or additionally, in some embodiments, the system module 100 further includes SSD(s) 112’ coupled to the I/O controller 106 directly. Conversely, the SSDs 112 are coupled to the communication buses 140. In an example, the communication buses 140 operates in compliance with Peripheral Component Interconnect Express (PCIe or PCI-E), which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112’, and HDD 114. These new non-transitory computer readable storage media include, but are not limited to, those manufactured from biological materials, nanowires, carbon nanotubes and individual molecules, even though the respective data storage technologies are currently under development and yet to be commercialized.

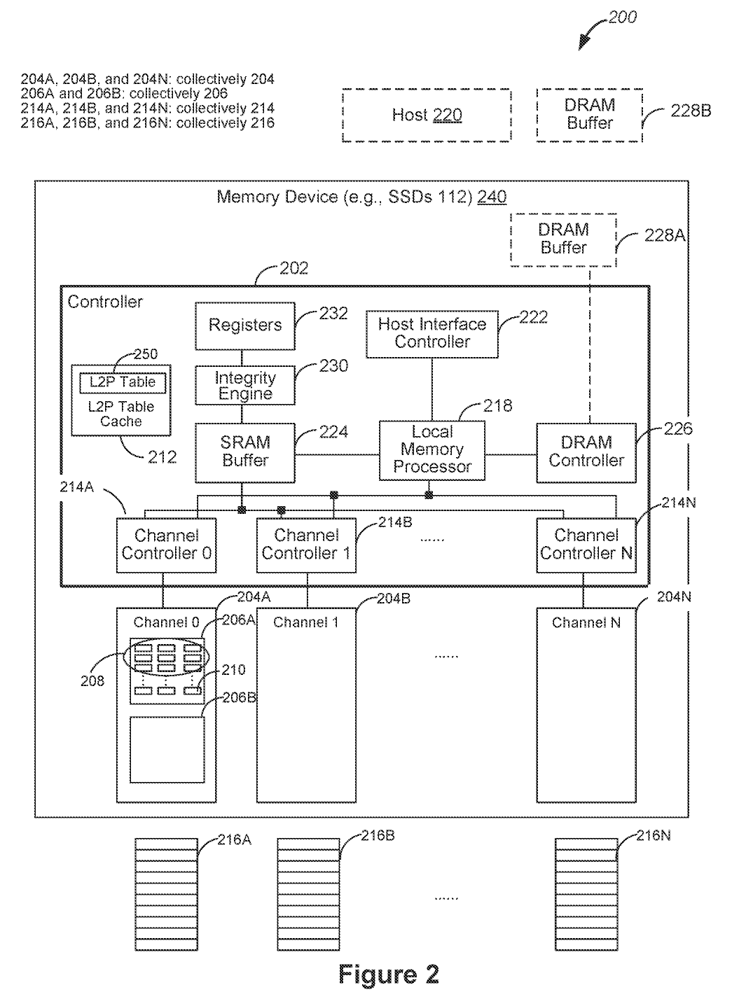

FIG. 2 is a block diagram of a memory system 200 of an example electronic device having one or more memory access queues, in accordance with some embodiments. The memory system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the memory system 200 and process the instructions and data to run an operating system and execute user applications. The memory system 200 includes one or more memory devices 240 (e.g., SSD(s)). Each memory device 240 further includes a controller 202 and a plurality of memory channels 204 (e.g., channel 204A, 204B, and 204N). Each memory channel 204 includes a plurality of memory cells. The controller 202 is configured to execute firmware level software to bridge the plurality of memory channels 204 to the host device 220. In some embodiments, each memory device 240 is formed on a printed circuit board (PCB).

Each memory channel 204 includes on one or more memory packages 206 (e.g., two memory dies). In an example, each memory package 206 (e.g., memory package 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the memory device 240 includes a plurality of superblocks. Each superblock includes a plurality of memory blocks each of which further includes a plurality of memory pages 210. For each superblock, the plurality of memory blocks are configured to be written into and read from the memory system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The memory device 240 stores information of an ordered list of superblocks in a cache of the memory device 240. In some embodiments, the cache is managed by a host driver of the host device 220, and called a host managed cache (HMC).

In some embodiments, the memory device 240 includes a single-level cell (SLC) NAND flash memory chip, and each memory cell stores a single data bit. In some embodiments, the memory device 240 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits. Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the memory device 240 corresponds to a single queue 216 of memory access requests. Each memory access request is optionally received internally from the memory device 240 to manage the respective memory channel 204 or externally from the host device 220 to write or read data stored in the respective channel 204. Specifically, each memory access request includes one of: a system write request that is received from the memory device 240 to write to the respective memory channel 204, a system read request that is received from the memory device 240 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a memory controller 202 to implement internal memory management functions including, but are not limited to, garbage collection, wear levelling, read disturb mitigation, memory snapshot capturing, memory mirroring, caching, and memory sparing.

In some embodiments, in addition to the channel controllers 214, the controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228A that is included in memory device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n – k) corresponds to integrity data of the user data, where k and n are positive integers. In some embodiments, the memory device 240 includes an integrity engine 230 (e.g., an LDPC engine) and registers 232, which include a plurality of registers or SRAM cells or flip-flops and are coupled to the integrity engine 230. The integrity engine 230 is coupled to the memory channels 204 via the channel controllers 214 and SRAM buffer 224. Specifically, in some embodiments, the integrity engine 250 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the memory system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the controller 202. Alternatively, in some embodiments, the memory system 200 includes a DRAM buffer 228A, and the L2P address indirection table 250 is stored in the DRAM buffer 228A. The local memory processor 218 of the controller 202 accesses the DRAM buffer 228A via a DRAM controller 226.

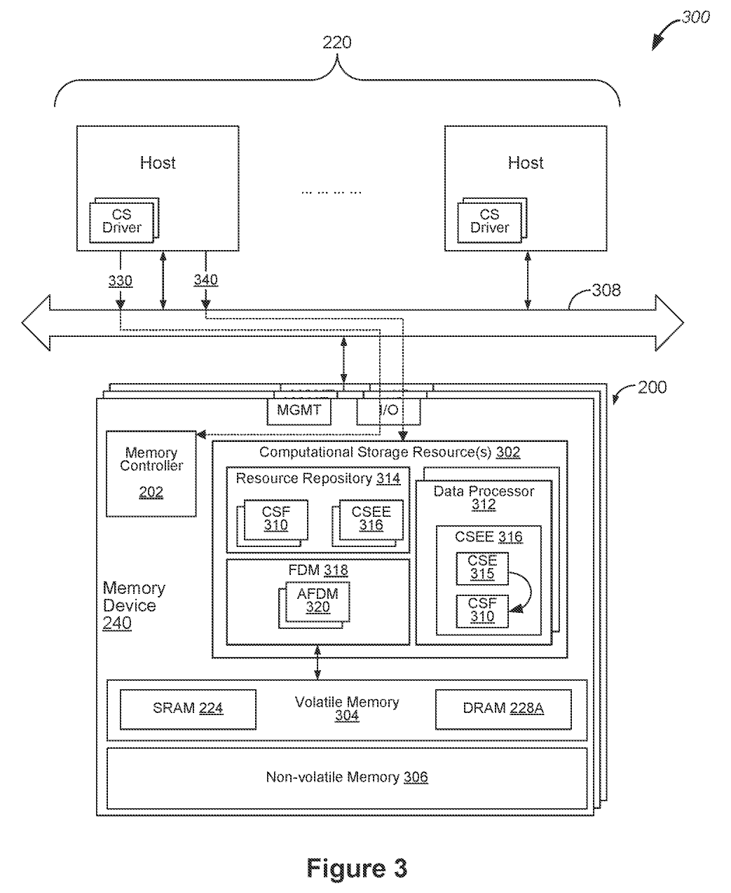

FIG. 3 is a block diagram of an example computer system 300 that includes a memory system 200 having an internal processing capability, in accordance with some embodiments. The memory system 200 is also called a computational storage device (CSD), and includes one or more memory devices 240 (e.g., SSDs). Each memory device 240 further includes a memory controller 202, a volatile memory 304, and a non-volatile memory 306 (e.g., memory channels 204). The host device(s) 220 and the one or more memory devices 240 of the memory system 200 are coupled to each other via a communication fabric 308. The communication fabric 308 includes a communication bus 140 (FIG. 1) that operates in compliance with a data bus standard, e.g., Peripheral Component Interconnect Express (PCIe), Ethernet standards. The host device(s) 220 are configured to issue memory access requests to write data into, and read data from, the non-volatile memory 306. The memory controller 202 accesses the non-volatile memory 306 in response to the memory access operations. Additionally, in some embodiments, the memory controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The volatile memory 304 of each memory device 240 further includes one or more of a L2P table cache 212, a SRAM buffer 224, and a DRAM buffer 228A, and is configured to store data temporarily while the memory controller 202 accesses the non-volatile memory 306 for memory accesses or internal memory management.

In some embodiments, the memory controller 202 is dedicated to processing the memory access requests and internal memory management functions. A memory device 240 further includes one or more computational storage resources (CSRs) 302 configured to implement data processing operations locally on the memory device 240. A set of predefined data processing operations are implemented to perform a computational storage function (CSF) 310, which is distinct from the memory access and internal memory management functions performed by the memory controller 202. In some embodiments, a computational storage resource 302 processes user data that are received from the host device(s) 220 or extracted from the non-volatile memory 306 during the data processing operations. In some embodiments, the processed data are stored into the non-volatile memory 306 or sent to the host device(s) 220 via the fabric 308. Further, in some embodiments, a subset of the user data, the process data, and intermediate data generated during the data processing operations is temporarily stored in the volatile memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the memory device 240. The resource repository 314 is a centralized location (e.g., memory space) storing various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that are used or generated by the computational storage engine 315 for performing a computational storage function 310. In some embodiments, the function data memory 318 is included in the volatile memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 22 issues a memory read or write request 330 to a memory device 240 of the memory system 200, and the memory controller 202 of the memory device 240 receives the memory read or write request 330 and accesses the non-volatile memory 306 accordingly. Alternatively, in some embodiments, a host device 22 issues a data processing request 340 to the memory device 240, and a data processor 312 of the computational storage resource 302 (e.g., the computational storage engine 315) receives the data processing request 340 and processes user data extracted from the data processing request or the non-volatile memory 306.

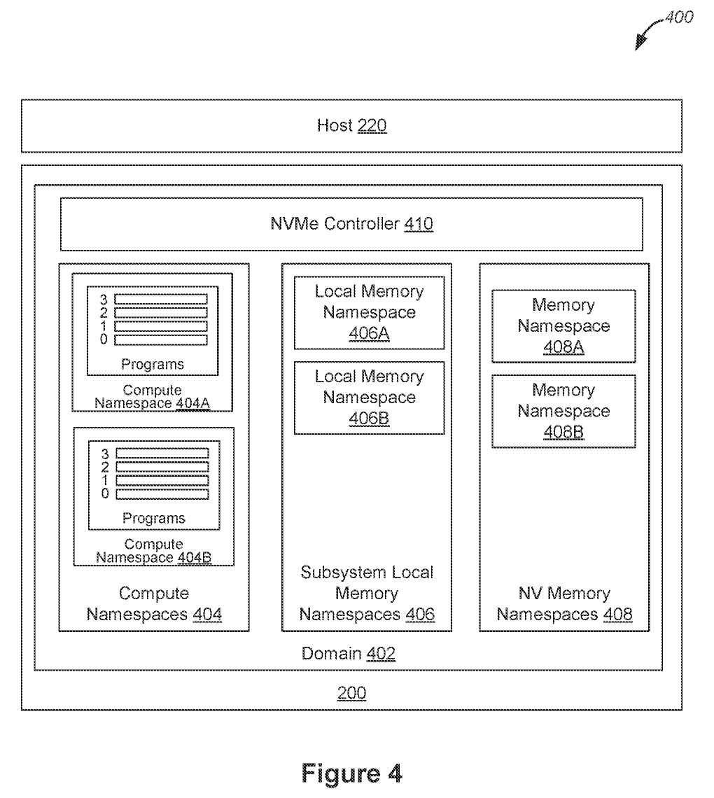

FIG. 4 is a block diagram of an example computer system 400 including a memory system 200 that operates in compliance with a storage access and transport protocol (e.g., nonvolatile memory express (NVMe)), in accordance with some embodiments. The memory system 200 includes one or more memory devices 240 each of which corresponds to a domain 402 according to the storage access and transport protocol. Each domain 402 corresponding to a respective memory device 240 includes a one or more compute namespace 404, local memory namespaces 406, memory namespaces 408, and a domain controller 410. Each namespace is a collection of LBAs accessible to, or associated with, a respective one of the plurality of programs.

A memory device 240 includes one or more processors having a computation capability (e.g., a memory controller 202, a data processor 312), a volatile memory 304 (e.g., a cache 212, a SRAM buffer 224, a DRAM buffer 228A), and a non-volatile memory 306. When the memory device 240 executes a plurality of programs, resources of the memory controller 202, the volatile memory 304, and the non-volatile memory 306 are allocated to implement the plurality of programs based on the storage access and transport protocol (e.g., NVMe). A plurality of compute namespaces 404 (e.g., 404A and 404B) correspond to, are configured to provide, instructions of the plurality of programs executed by the one or more programs of the memory device 240. Resources of the volatile memory 304 are allocated based on a plurality of local memory namespaces 406 (e.g., 406A and 406B) to facilitate execution of the plurality of programs by the memory device 240, so are resources of the non-volatile memory 306 allocated based on a plurality of memory namespaces 408 (e.g., 408A and 408B). It is noted that, in some embodiments, a number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the memory device 240. In some situations, input data that are processed, and output data that are generated, by these instructions are temporarily stored based on the local memory namespace 406A. In some situations, the input data are extracted based on the non-volatile memory namespace 408A, and the output data are stored based on the non-volatile memory namespace 408A. By these means, namespace allocation and utilization in the domain 402 corresponding to the memory device 240 are managed according to the storage access and transport protocol.

In some embodiments, the storage access and transport protocol includes a NVMe protocol for accessing flash storage (e.g., SSDs) via a PCI Express (PCIe) bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each memory device 240 (e.g., SSD) as a standard NVMe storage device using the NVMe protocol. The host device 220 is configured to read and write data and implement data processing operations on the memory device 240 using NVMe commands.

In some embodiments, the host device 220 executes an operating system (e.g., a Linux operating system) on a host side, and the CSRs 302 (FIG. 3) of the memory device 240 executes the operating system (e.g., an embedded Linux operating system) on a storage side.

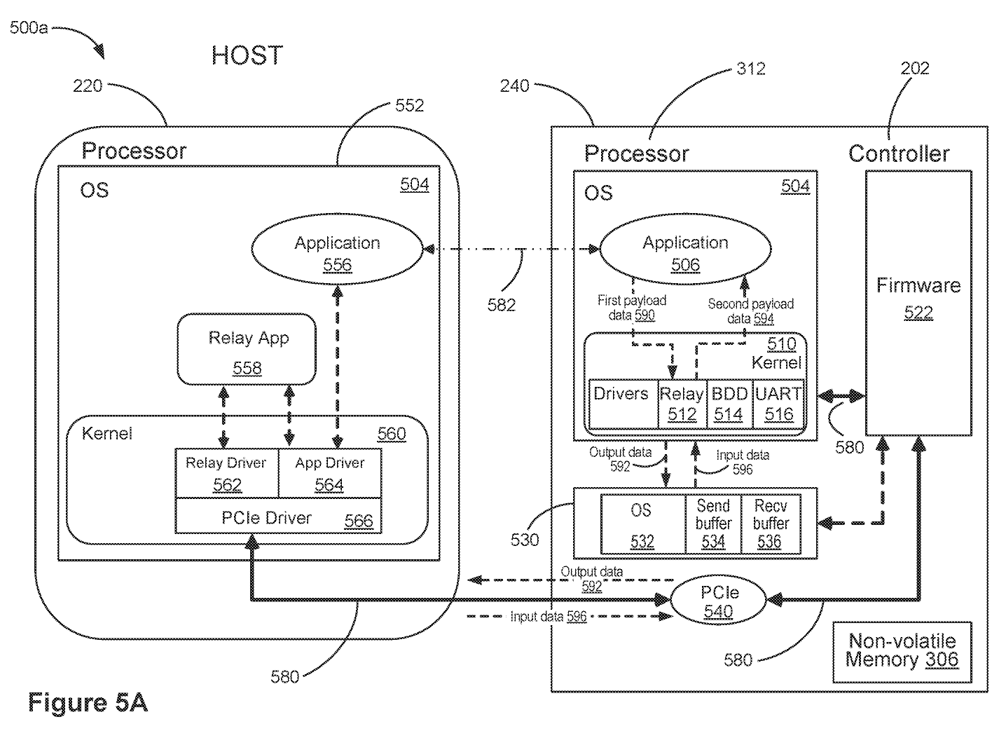

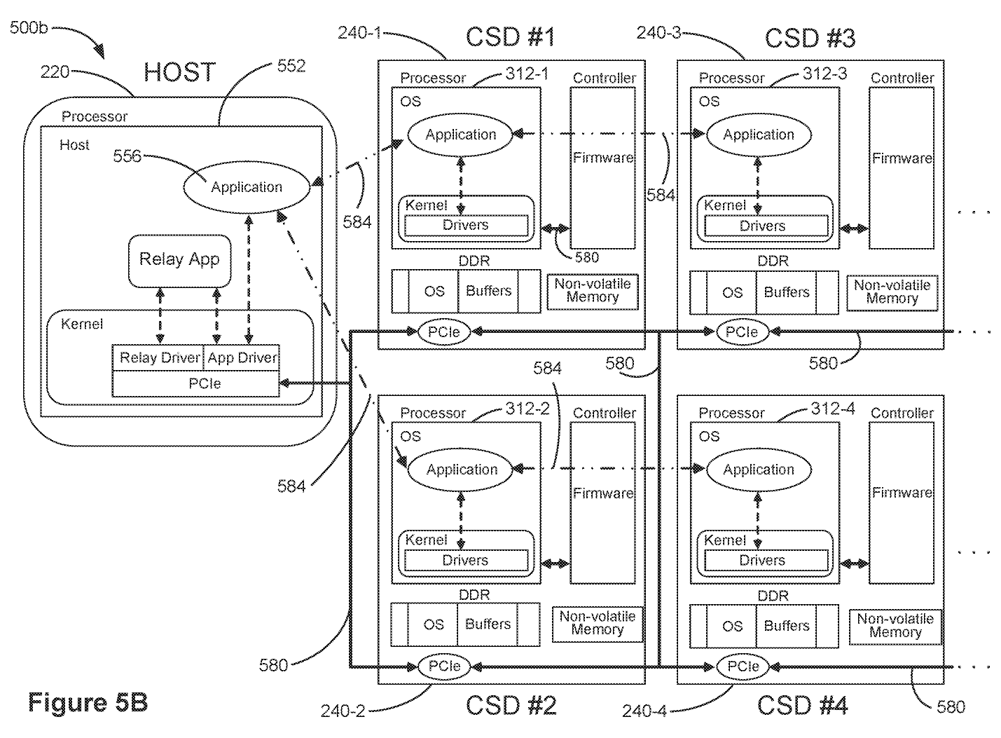

FIGS. 5A and 5B are block diagrams of two example electronic systems 500a and 500b having virtual communication links for communicating data between memory device(s) 240 and a host device 220, in accordance with some embodiments. The memory device 240 is transformed to a computational storage device 240 by incorporating at least one computing element (e.g., the data processor 312 in FIG. 3). In the context of this application, the memory device 240 is used in an exchanged manner with the computational storage device 240.

FIG. 5A illustrates a first example virtual communication link 582 that is configured to communicate data bidirectionally between the computational storage device 240 and the host device 220 according to a TCP/IP addressing protocol and a PCIe interface standard. The host device 220 includes a local computer and/or a remote server and has a host IP address. The host device 220 and the computational storage device 240 are coupled to one another and communicate data via a data bus 580 and an input/output data interface 540 of the computational storage device 240. In some embodiments, the computational storage device 240 sends payload data originally in a TCP/IP format (e.g., TCP/IP packets) to the host device 220 at a target IP address via the data bus 580. In some embodiments, the computational storage device 240 receives data that are sent from the host device 220 via the data bus 580. In some embodiments, the host device 220 sees the computational storage device 240 as a standard NVMe storage device. The host device 220 reads and writes data as well as controls the computational storage device 240 using standard NVMe commands. In some embodiments, the host device 220 sends payload data originally in the TCP/IP format (e.g., TCP/IP packets) to the computational storage device 240 at target IP addresses via the data bus 580. In some embodiments, the host device 220 receives data that are sent from the computational storage device 240 via the data bus 580. In this scenario, bidirectional communication is established, forming the first example virtual communication link 582 between applications of the computational storage device 240 and the host device 220. In some embodiments, the data bus 580 is a PCIe data bus. Specifically, the data bus 580 is configured to communicate data between the computational storage device 240 and the host device 220 according to the PCIe interface standard.

The host device 220 includes a host processor 552 configured to execute an operating system 504 on a host side and jointly with the computational storage device 240. On the host side, the operating system 504 includes one or more of: a host application 556 for implementing predefined functions, a relay application 558 for relaying data, and a host-side kernel 560 including one or more data drivers. For example, the host-side kernel 560 includes one of a set of data drivers, e.g., a relay driver 562 associated with the relay application 558, an application driver 564 associated with the host application 556, and a PCIe driver 566 associated with data communication via the data bus 580. In some embodiments, the host application 556 is configured to generate TCP/IP packets, and the application driver 564 acts as a virtual network interface for transmitting the TCP/IP packets. In some embodiments, the relay application 558 is configured to receive data from the host application 556 and convert the data to TCP/IP packets for data transfer via a virtual network. Alternatively, in some embodiments, the relay application 558 reads incoming messages including the TCP/IP packets from the host application 556, and forwards the incoming messages to a virtual network interface for data transfer via the virtual network. Further, in some embodiments, the relay application 558 is configured to generate outgoing messages including the TCP/IP packets (e.g., generated by the application 556 or 558) according to a data protocol (e.g., PCIe) associated with the data bus 580, allowing the outgoing message to be transmitted via the data bus 580.

The computational storage device 240 includes a data processor 312, a memory controller 202, a memory buffer 530, a non-volatile memory 306 (not shown in FIG. 5A), and an input/output data interface 540. The input/output data interface 540 is configured to couple to the data bus 580 and communicate data via the data bus 580. The data bus 580 is configured to communicate data between the input/output data interface 540 and the host device 220 according to the PCIe interface standard. The data processor 312 is coupled to the input/output data interface 540 and has a device IP address. The data processor 312 is configured to execute the operating system 504 on a storage side. The operating system 504 includes a device application 506 and a storage-side kernel 510. The storage-side kernel 510 includes device drivers: a network relay device driver 512, a block device driver 514, a universal asynchronous receiver-transmitter (UART) device driver 516. The memory controller 202 is coupled to the input/output data interface 540. The memory controller 202 is distinct from the data processor 312 and configured to execute a firmware 522.

The memory buffer 530 is coupled to the data processor 312 and the memory controller 202. The memory buffer 530 includes a first buffer portion 532 (also called an operating system buffer 532) allocated to the data processor 312 and a second buffer portion allocated to the memory controller 202. The second buffer portion includes an outgoing buffer portion 534 (also called a send buffer 534) and a receiving buffer portion 536 (also called a receive buffer 536). The send buffer 534 is configured to store data to be sent and the receive buffer 536 is configured to store data being received. In some embodiments, the memory buffer 530 is a double data rate dynamic random-access memory (DDR DRAM).

The non-volatile memory 306 of the computational storage device 240 is coupled to the data processor 312 and the memory controller 202. The non-volatile memory 306 includes a plurality of memory blocks. A subset of the plurality of memory blocks of the non-volatile memory 306 is reserved for the data processor 312. In some embodiments, the non-volatile memory 306 includes a NAND flash.

In some embodiments, the data processor 312 of the computational storage device 240 is configured to generate first payload data 590 having a TCP/IP packet format (e.g., TCP/IP packets). The first payload data 590 includes at least one of the device IP address of the data processor 312 and the host IP address of the host device 220 (e.g., the host IP address of the host processor 552). In some embodiments, the data processor 312 is configured to convert the first payload data 590 to output data 592 having a PCIe packet format (e.g., PCIe packets). For instance, the storage-side kernel 510 is configured to convert data between TCP/IP packets and PCIe packets.

In some embodiments, the data processor 312 is configured to provide the output data 592 to the input/output data interface 540 for communicating the output data 592 via the data bus 580. Specifically, the output data 592 is stored in the operating system buffer 532, after the output data 592 being converted. The memory controller 202 is configured to move the output data 592 stored in the operating system buffer 532 to the send buffer 534, before the output data 592 are sent to the input/output data interface 540. The memory controller 202 sends the output data 592 stored in the send buffer 534 to the host device 220 via the input/output data interface 540 and the data bus 580.

In some embodiments, the data processor 312 is configured to obtain input data 596 having the PCIe packet format (e.g., PCIe packets) provided via the input/output data interface 540. The input data 596 includes the device IP address. Specifically, the memory controller 202 receives the input data 596 having the PCIe packet format (e.g., PCIe packets) from the input/output data interface 540, stores the input data 596 in the receive buffer 536 of the memory buffer 530, and sends an incoming notification to the data processor 312. In some embodiments, the memory controller 202 moves the input data 596 stored in the receive buffer 536 to the operating system buffer 532, after the input data 596 are received via the input/output data interface 540. In some embodiments, the input data 596 includes at least one of the device IP address of the data processor 312 and the host IP address of the host device 220 (e.g., the host IP address of the host processor 552).

In some embodiments, the data processor 312 is configured to obtain the input data 596 stored in the operating system buffer 532 and convert the input data 596 to second payload data 594 data having a TCP/IP package format (e.g., TCP/IP packets). The second payload data 594 include at least the device IP address. In some embodiments, the storage-side kernel 510 converts data between TCP/IP packets and PCIe packets.

In some embodiments, the first example virtual communication link 582 is formed between the device application 506 of the data processor 312 and the host application 556 of the host processor 552 for bidirectionally transferring TCP/IP packets. Specifically, the data processor 312 is configured to couple to the first example virtual communication link 582 that is configured to bidirectionally transfer TCP/IP packets between the data processor 312 and the host processor 552 according to the TCP/IP addressing protocol. At the computational storage device 240, the data processor 312 generates TCP/IP packets having the device IP address and/or the host IP address, converts TCP/IP packets to PCIe packets, and sends PCIe packets to the host processor 552. At the host device 220, the host processor 552 generates TCP/IP packets having the host IP address and/or the device IP address, converts TCP/IP packets to PCIe packets, and sends PCIe packets to the data processor 312. In this scenario, the data processor 312 sends PCIe packets to and receives PCIe packets from the host processor 552 via the input/output data interface 540 and the data bus 580. In some embodiments, the data processor 312 and the host processor 552 operate on a unified operating system such as Linux, such that the device application 506 replicates functions of the host application 556 through a mutual connection (e.g., the first example virtual communication link 582). In some embodiments, the operating system 504 includes one or more device applications on a storage side (e.g., in the computational storage device 240).

In some embodiments, the data processor 312 is configured to operate according to a notification mechanism including at least one of interrupt, polling, or doorbell. Stated another way, a handshaking process is applied between the computational storage device 240 and the host device 220. In some embodiments, the handshaking process includes one or more of: interrupt, polling, and doorbell that are available in typical PCIe bus implementation.

In some embodiments, the data bus 580 is configured to communicate data according to the PCIe interface standard and does not include an ethernet cable. In other words, no physical ethernet cable is required to establish the first example virtual communication link 582 between the device application 506 and the host application 556 for bidirectionally transferring TCP/IP packets. TCP/IP packets that are generated by the data processor 312 are converted to PCIe packets by the storage-side kernel 510 before being sent to the host device 220. TCP/IP packets that are generated by the host processor 552 are converted to PCIe packets before being sent to the computational storage device 240. Since PCIe packets are transferred between the computational storage device 240 and the host device 220 via the input/output data interface 540 and the data bus 580 according to the PCIe interface standard, a physical ethernet cable, which is based on the TCP/IP addressing protocol, is not required.

FIG. 5B illustrates a second example virtual communication link 584 that is configured to communicate data bidirectionally between one or more computational storage device 240 (e.g., 240-1, 240-2, 240-3, . . ., 240-k; k being an integer) and the host device 220 according to the TCP/IP addressing protocol and the PCIe interface standard, in accordance with some embodiments. Each of the computational storage devices 240-1 to 240-k includes a respective data processor 312 and a non-volatile memory 306. The computational storage devices 240-1 to 240-k send PCIe packets to and receive PCIe packets from the host device 220. In some embodiments, data processors (e.g., 312-1, 312-2, 312-3, . . ., 312-k) of the computational storage devices 240-1 to 240-k are configured to couple to the second example virtual communication link 584 that is configured to bidirectionally transfer TCP/IP packets according to the TCP/IP addressing protocol. The second example virtual communication link 584 is formed between applications of the data processors 312-1 to 312-k and the host application 556 of the host processor 552 for bidirectionally transferring TCP/IP packets.

In some embodiments, the data processors 312-1 to 312-k and the host processor 552 form a cluster of processors, and each data processor has a respective IP address for sending and receiving TCP/IP packets. For instance, the data processor 312-1 of the computational storage devices 240-1 is configured to send and receive TCP/IP packets to and from each processor of the cluster of processors (e.g., the data processors 240-2 to 240-k and the host processor 552). In another instance, the data processor 312-2 of the computational storage devices 240-2 is configured to send and receive TCP/IP packets to and from each processor of the cluster of processors (e.g., the data processors 240-1 and 240-3 to 240-k as well as the host processor 552). In some embodiments, the data bus 580 communicates data between the computational storage devices 240-1 to 240-k and the host device 220 according to the PCIe interface standard and does not require an ethernet cable. In other words, no physical ethernet cable is required to establish the second example virtual communication link 584.

Further details of the computational storage device 240 and the host device 220 are presented below.

### Linux operating system

In some embodiments, the operating system 504 is executed on the host device 220 and the data processor 312 jointly, and acts as an embedded Linux operating system on a storage side (e.g., on the data processor 312 (e.g., a multi-core CPU), which is included on the same system-on-chip (SoC) of the memory controller 202).

In some embodiments, on the storage side, the embedded Linux operating system is initiated by the firmware 522 of the memory controller 202. The embedded Linux operating system includes a Linux kernel (e.g., the storage-side kernel 510). A Linux kernel image along with a bootloader code and a device tree structure is stored in the non-volatile memory 306 (e.g., a NAND flash) of the computational storage device 240. The firmware 522 of the memory controller 202 reads all information from the NAND flash and loads it into the memory buffer 530 (e.g., a DDR memory, a DDR DRAM). The firmware 522 sets reset vectors of the data processor 312 to execute Linux code. Moreover, the embedded Linux operating system has access to the data bus 580. In some embodiments, the access is limited by address ranges defined in the device tree structure.

In some embodiments, the Linux kernel is a main process of the embedded Linux operating system. The Linux kernel controls executions of all other processes and contains device drivers (e.g., the network relay device driver 512, the block device driver 514, the UART device driver 516) to interface with external devices, such as storage devices, serial ports, display ports, network interfaces. In some embodiments, storage devices, serial ports, display ports, and/or network interfaces are simulated by proprietary, custom built device drivers that interact with the firmware 522 of the memory controller 202 through common memory-mapped addresses (e.g., mailboxes). In some embodiments, the embedded Linux operating system may not correspond to a tangible external device to interact with.

### Root File System

In some embodiments, the embedded Linux operating system (e.g., the operating system 504) is loaded from memory, and executes code at run-time. The code is part a root file system. In some embodiments, this operation is part of either the operating system such as command interpreters and network services, or actual user applications.

In some embodiments, the root file system is pre-loaded to the memory buffer 530 and mounted as a random access memory filesystem. Alternatively, in some embodiments, the root file system is stored in the NAND flash and mounted from the NAND flash. If the root file system is stored in the NAND flash, the embedded Linux operating system loads and keeps in the DDR memory (e.g., the memory buffer 530) only tables of the root file system with file names and logical block addressing (LBA) lists. In some embodiments, the embedded Linux operating system loads files containing user application code from the NAND flash to the DDR memory only when it is time to execute.

In some embodiments, the embedded Linux operating system includes a custom-built block device driver for mounting the root file system from the NAND flash. The custom-built block device driver interfaces with the firmware 522 of the memory controller 202 to read and write LBA lists to and from the NAND flash.

### Device Tree

In some embodiments, a device tree is a structure that is loaded to a memory device 240 and read by the Linux kernel (e.g., the storage-side kernel 510) when it starts to run. The Linux kernel finds the device tree in a flattened device tree block of the DDR memory (e.g., the memory buffer 530 in FIG. 5A, DRAM buffer 228A in FIG. 2) and starts to execute the device tree. Prior to the device tree being executed by the Linux kernel, the flattened device tree block of the DDR memory is filled by the firmware 522 of the memory controller 202 or a bootloader.

In some embodiments, the flattened device tree block includes information about available hardware, such as CPU number, model, and clock rate, interruption numbers, memory-mapped addresses, and any other configuration options that the device drivers need at boot time. Additionally, the device tree includes available memory range designated for the embedded Linux operating system (e.g., corresponding to the operating system 504 executed jointly by the host device 220 and the computational storage device 240).

In some embodiments, a spin-table in the device tree is used to boot a symmetrical multi-processor system (e.g., a multi-core symmetric multiprocessing including a primary core and other secondary cores) into the Linux kernel, and a spin loop code is written in the DDR memory. Secondary cores are directed to execute when the primary core executes Linux code. In some embodiments, the primary core refers to the device tree for a respective CPU release address of each secondary core, writes to the respective CPU release address, and releases the secondary cores.

In some embodiments, the flattened device tree block enables data communication between the firmware 522 of the memory controller 202 and the storage-side kernel 510. In some embodiments, the flattened device tree block serves to convey runtime and configuration data, such as kernel parameters string. The kernel parameters string specifies a serial device to be employed as a console. The kernel parameters string designates block device and partition that is used for the root file system and for memory location of an initial RAM disk image.

### Network relay device driver

In some embodiments, the Linux kernel (e.g., the storage-side kernel 510) implements the TCP/IP addressing protocol and offers service access points to any user space process, such as teletypewriter virtual consoles, secure shell services, network file system servers, and more. Specifically, TCP/IP is a standard ecosystem for controlling, deploying, or accessing services and/or user applications. In some embodiments, the Linux kernel implements a TCP/IP stack locally. The embedded Linux operating system (e.g., the operating system 504) may have no physical network interface and include a virtual network interface or a virtual storage interface emulated using shared DRAM. Alternatively, the embedded Linux operating system (e.g., the operating system 504) may be couped to the PCIe data bus (e.g., the data bus 580).

In some embodiments, the custom-built network relay device driver 512 is configured to simulate a physical network interface. The network relay device driver 512 acts as a normal network driver towards the Linux kernel. A user assigns an IP address to the network interface and opens a file descriptor to read and write data from and to the network interface. In some embodiments, the data is written to a designated send buffer 534 or read from the receive buffer 536 with a need of assembling network frames for transmission.

In some embodiments, the DDR memory (e.g., the memory buffer 530) includes a control structure in that tracks buffer start and end pointers of the send buffer 534 and receive buffer 536. In some embodiments, a semaphore method is applied to control the send buffer 534 and receive buffer 536 when the firmware 522 of the memory controller 202 or the network relay device driver 512 change the buffers.

### Block Device Driver

In some embodiments, the block device driver 514 is an interface code that reads blocks of data (e.g., LBAs) from a storage device into the DDR memory (e.g., the memory buffer 530) or writes blocks of data from the DDR memory into a storage device.

In some embodiments, when the Linux kernel (e.g., the storage-side kernel 510) is booting, the block device driver 514 looks at runtime configuration string to determine block device and partition for the root file system or if an initial ramdisk (initrd) scheme is applied in the DDR memory.

In some embodiments, when one of partitions of the custom-built block device driver 514 is designated as the root file system, the embedded Linux operating system (e.g., the operating system 504) starts to read a partition table of the block device. After the LBAs that limit a start and end of the root file system partition are determined, the embedded Linux operating system starts to read from the beginning of the partition table, look for file system tables, and load the file system tables to the DDR memory. Accordingly, the root file system is available for the embedded Linux operating system to find an application file, load it into the DDR memory, and start executing it.

In some embodiments, the block device driver 514 reads the LBAs by sending messages to an Inbound Firmware command mailbox. The messages include a sector logical block addressing (SLBA) and size of data to be read. The messages also include a scatter-gather list (SGL) that indicates location in the DDR memory where the data should be written. When the firmware 522 completes writing the data to the DDR memory, it sends a message to an Outbound Firmware command mailbox. For a piece of data space, a physical region page (PRP) is mapped to a physical page, and SGL is mapped to any size of continuous physical space.

In some embodiments, the block device driver 514 writes data in the DDR memory by at least sending messages to the Inbound Firmware command mailbox. The messages include the SLBA and size of data to be written. The messages also include an SGL that indicates location in the DDR memory where the data to be fetched. When the firmware 522 completes writing the data to the DDR memory, it sends a message to the Outbound Firmware command mailbox. storage-side kernel

### Firmware

In some embodiments, a firmware 522 is executed by the memory controller 202 (FIGS. 2 and 5). The firmware 522 is a computational module responsible for traditional NVMe storage functionality. The firmware 522 controls the memory controller 202, PCIe interface (e.g., the input/output data interface 540), NVMe stack, data processing modules, direct memory access (DMA) engines, and UARTs (e.g., the UART device driver 516). The firmware 522 shares the data bus 580 with the embedded Linux operating system (e.g., the operating system 504).

In some embodiments, each access to NAND data stored in the non-volatile memory 306, from the host side or the storage side of the operating system 504, is controlled by the firmware 522 executed by the memory controller 202. Each interaction between the host device 220 and the data processor 240 occurs under control of the firmware 522. In some embodiments, the firmware 522 controls life cycles of the embedded Linux operating system as well as boot sequence of respective cores of the data processor 312 designated to the embedded Linux operating system. In some embodiments, the firmware 522 loads the Linux kernel image from the NAND flash (e.g., the non-volatile memory 306 described above) to the DDR memory (e.g., the memory buffer 530) and properly setting reset vectors. In some embodiments, the firmware 522, at any time, resets or halts the respective cores designated to the embedded Linux operating system.

### Host Device

Under some circumstances, the host device 220 sees the computational storage device 240 (e.g., 240-1, 240-2, 240-3, . . . 240-k) as a standard NVMe storage device. The host device 220 read and write data as well as control the computational storage device 240 using standard NVMe commands. In some embodiments, the host device 220 controls and interacts with the embedded Linux operating system (e.g., the operating system 504) loaded on the computational storage device 240 by way of communication via a data bus 580 (e.g., associated with a PCIe data protocol).

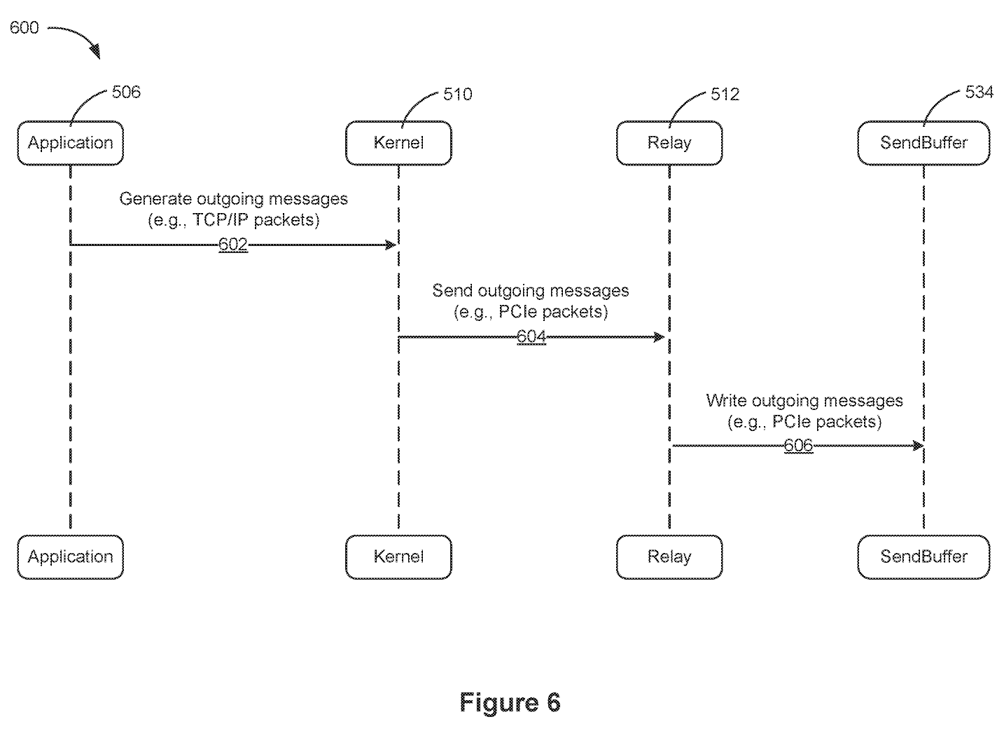

FIG. 6 is a flow diagram of an example process 600 of transmitting messages to the host device 220 via a virtual communication link, in accordance with some embodiments. The computational storage device 240 executes the device application 506 that provides the messages to be sent to the host device 220. In some embodiments, the virtual communication link is the first example virtual communication link 582 or the second example virtual communication link 584. In some embodiments, the device application 506 interacts with an embedded Linux operating system of the computational storage device 240.

The device application 506 generates (operation 602) outgoing messages (e.g., payload data) in forms of TCP/IP packets and sends the TCP/IP packets to the storage-side kernel 510. The outgoing messages have the device IP address and/or the host IP address. The storage-side kernel 510 converts the TCP/IP packets into PCIe packets and forwards (operation 604) the PCIe packets to the network relay device driver 512 (e.g., a relay interface). The network relay device driver 512 writes (operation 606) PCIe packets to the send buffer 534 for storing the outgoing messages.

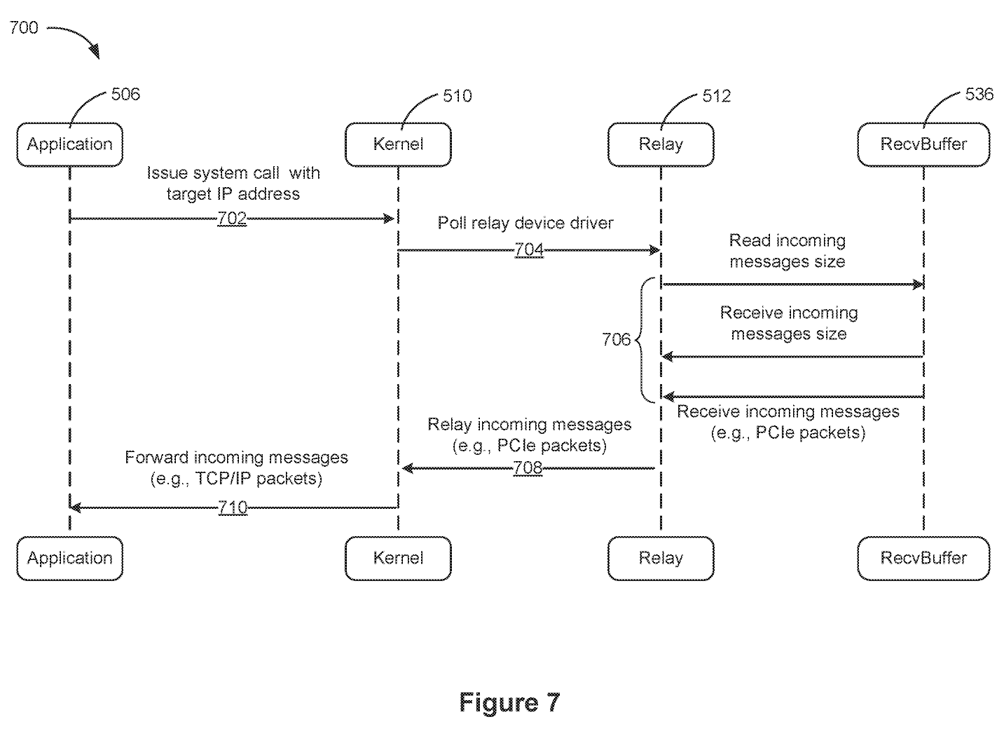

FIG. 7 is a flow diagram of an example process 700 of receiving messages by the computational storage device 240 via a virtual communication link, in accordance with some embodiments. The computational storage device 240 executes a device application 506 (FIG. 5A) that receives the messages from the host device 220. In some embodiments, the virtual communication link is the first example virtual communication link 582 or the second example virtual communication link 584. In some embodiments, the device application 506 is executed on an embedded Linux operating system.

The device application 506 issues (operation 702) a system call according to a target IP address (e.g., the host IP address) to the storage-side kernel 510. The storage-side kernel 510 polls (operation 704) the network relay device driver 512 (e.g., a relay interface) to initiate polling incoming messages. The network relay device driver 512 reads (operation 706) the incoming messages (e.g., PCIe packets) and size of the incoming messages from the receive buffer 536. After receiving the incoming messages, the network relay device driver 512 relays (operation 708) the incoming messages to the storage-side kernel 510. The storage-side kernel 510 converts the incoming messages from PCIe packets to TCP/IP packets and forwards (operation 710) the incoming messages to the device application 506.

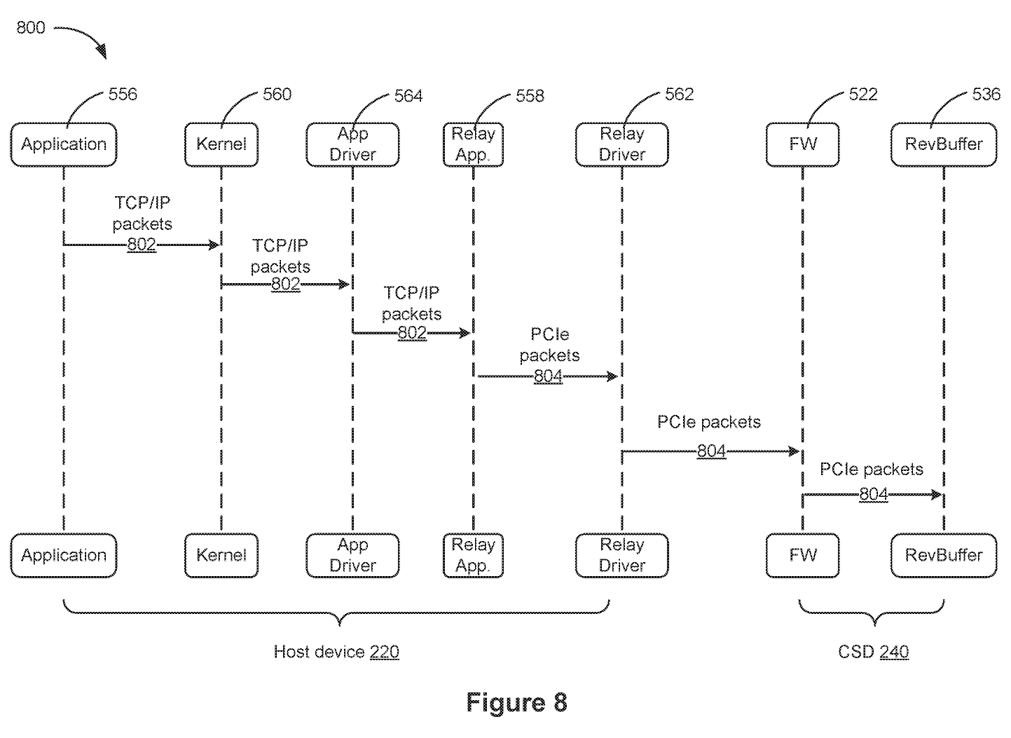

FIG. 8 is a flow diagram 800 of an example process of receiving messages by the host device 220 via a virtual communication link, in accordance with some embodiments. In some embodiments, the virtual communication link is the first example virtual communication link 582 or the second example virtual communication link 584. In some embodiments, the host application 556 is operated on a Linux operating system.

In some embodiments, the host application 556 generates outgoing messages (e.g., payload data) in forms of TCP/IP packets 802 and send the TCP/IP packets 802 to the host-side kernel 560. The outgoing messages have the device IP address and/or the host IP address. The host-side kernel 560 forwards the TCP/IP packets 802 to the application driver 564. The application driver 564 forwards the TCP/IP packets to the relay application 558. At the relay application 558, the TCP/IP packets 802 are converted into PCIe packets 804 and encapsulated as a payload. The relay application 558 sends the payload in forms of PCIe packets 804 to the relay driver 562. The relay driver 562 sends the payload to the computational storage device 240 via the PCIe host driver 566. The firmware 522 of the memory controller 202 of the computational storage device 240 receives the vendor unique command and retrieves the outgoing messages in forms of PCIe packets 804. The firmware 522 appends the outgoing messages to the receive buffer 536.

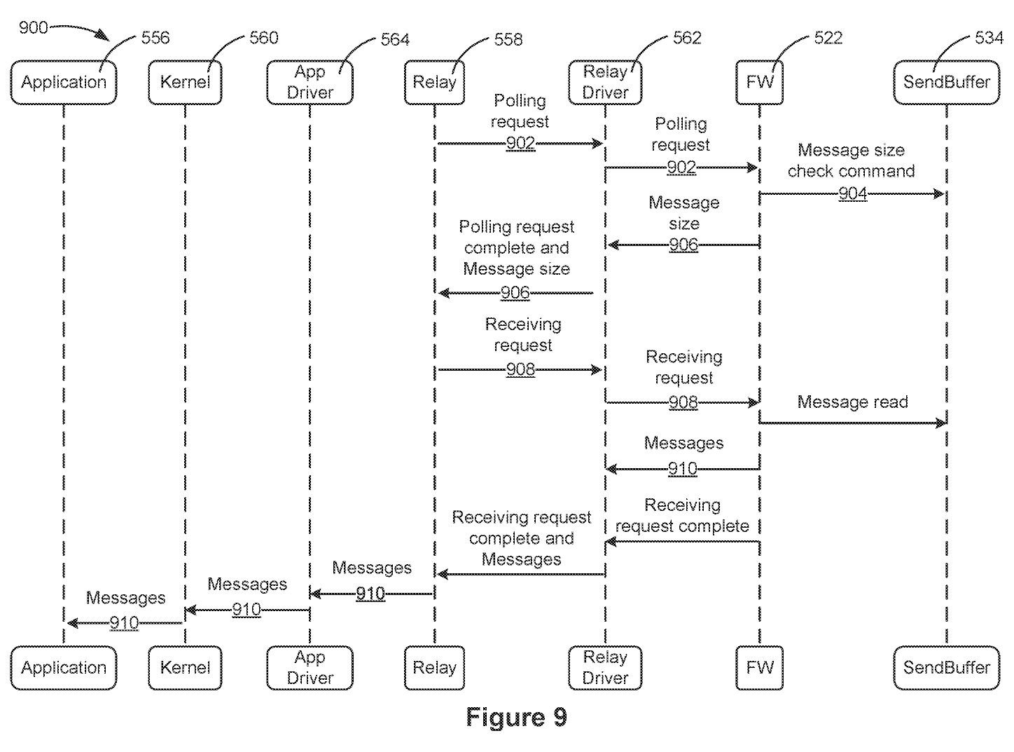

FIG. 9 is a flow diagram of an example process 900 of receiving messages by the host device 220 via a virtual communication link, in accordance with some embodiments. In some embodiments, the virtual communication link is the first example virtual communication link 582 or the second example virtual communication link 584. In some embodiments, the host application 556 is operated on a Linux operating system.

The relay application 558 initiates a periodic check (e.g., polling) 902 for incoming messages and sends a command (e.g., a message size check command 904) to the send buffer 534 via the relay driver 562 and the firmware 522. The command is used to fetch a size of the send buffer 534 of the computational storage device 240. The firmware 522 of the memory controller 202 sends a message 906 including the size of the send buffer 534 and a completion notification (e.g., host polling request complete) to the host device 220. The relay application 558 receives the message 906 including the size of the send buffer 534 and writes the size of the send buffer 534 to the host memory buffer. If the send buffer 534 not empty, the relay application 558 sends another command 908 to read the send buffer 534. This command 908 includes the size of incoming messages 910 and a PRP or SGL to the host memory buffer to which the incoming messages are directed. The firmware 522 sends the incoming messages 910 to the host device 220. In situations where new messages are sent at the meantime or not all messages have been fully retrieved, the new messages and/or the messages that have not been retrieved remain in the send buffer 534 until the next time the host device 220 sends a polling request. The application driver 564 reads the incoming messages from the host memory buffer and send the incoming messages 910 to the host-side kernel 560. The host application 556 reads and processes the incoming messages 910 via the host-side kernel 560.

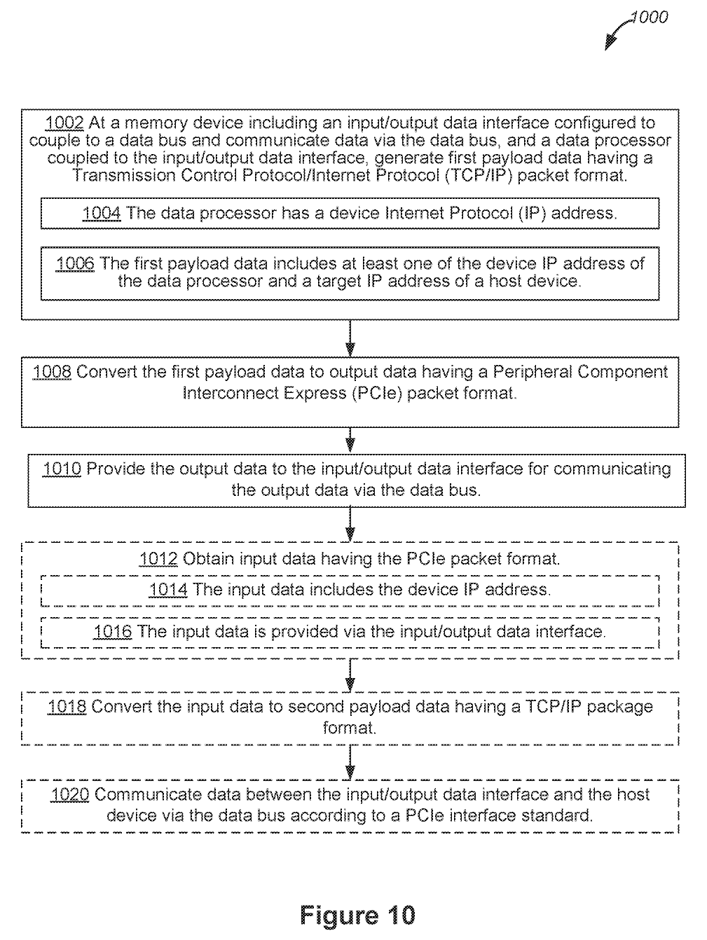

FIG. 10 is a flow diagram of an example method 1000 of creating a virtual communication link or network, in accordance with some embodiments. The method 1000 is applied to create a virtual communication link (e.g., 582 of FIG. 5A) between a host device 220 (e.g., FIGS. 2 and 5A) and a memory device 240 (e.g., FIGS. 2 and 5A) or a virtual communication network among a plurality of devices. The method 1000 includes at a memory device 240 (e.g., FIGS. 2 and 5A) including an input/output data interface 540 (e.g., FIG. 5A) configured to couple to a data bus 580 (e.g., FIG. 5A) and communicate data via the data bus 580, and a data processor 312 (e.g., FIGS. 3 and 5A) coupled to the input/output data interface 540, generating (1002) first payload data 590 (e.g., FIG. 5A) having a Transmission Control Protocol/Internet Protocol (TCP/IP) packet format. The data processor 312 has (1004) a device Internet Protocol (IP) address. The first payload data 590 includes (1006) at least one of the device IP address of the data processor 312 and a target IP address of a host device 220 (e.g., FIGS. 2 and 5A). The method 1000 also includes converting (1008) the first payload data 590 to output data 592 (e.g., FIG. 5A) having a Peripheral Component Interconnect Express (PCIe) packet format. The method 1000 further includes providing (1010) the output data 592 to the input/output data interface 540 for communicating the output data 592 via the data bus 580. The method 1000 further includes obtaining (1012) input data 596 (e.g., FIG. 5A) having the PCIe packet format. The input data 596 includes (1014) the device IP address. The input data 596 is (1016) provided via the input/output data interface 540. The method 1000 further includes converting (1018) the input data 596 to second payload data 594 (e.g., FIG. 5A) having a TCP/IP package format. The method 1000 further includes communicating (1020) data between the input/output data interface 540 and the host device 220 via the data bus 580 according to a PCIe interface standard.

In some embodiments, the memory device 240 further includes a memory controller 202 (e.g., FIGS. 2 and 5A) coupled to the input/output data interface 540 and distinct from the data processor 312. The method 1000 further includes sending, by the memory controller 202, the output data 592 to the host device 220 via the input/output data interface 540. Further, in some embodiments, the memory device 240 further includes a memory buffer 530 (e.g., FIG. 5A) coupled to the data processor 312 and the memory controller 202. The memory buffer 530 includes a first buffer portion 532 (e.g., FIG. 5A) allocated to the data processor 312 and a second buffer portion (e.g., 534 and 536 of FIG. 5A) allocated to the memory controller 202. The first buffer portion 532 is configured to store the output data 592. The memory controller 202 is configured to move the output data 592 stored in the first buffer portion 532 to the second buffer portion (e.g., 534 and 536) before sending the output data 592 to the input/output data interface 540. Further, in some embodiments, the memory controller 202 is configured to receive input data 596 (e.g., FIG. 5A) having the PCIe packet format from the input/output data interface 540, store the input data 596 in a memory buffer 530 (e.g., FIG. 5A) and send an incoming notification to the data processor 312. Further, in some embodiments, the data processor 312 further includes a non-volatile memory 306 (e.g., FIGS. 3 and 5A) coupled to the data processor 312 and the memory controller 202. The non-volatile memory 306 includes a plurality of memory blocks. A subset of the plurality of memory blocks is reserved for the data processor 312. Additionally, in some embodiments, the data processor 312 is configured to obtain the input data 596 from the memory buffer 530 and convert the input data 596 to second payload data 594 (e.g., FIG. 5A) having the TCP/IP packet format. The second payload data 594 includes at least the device IP address. Additionally, in some embodiments, the memory buffer 530 further includes an outgoing buffer portion 534 (e.g., FIG. 5A) configured to store the output data 592 and a receiving buffer portion 536 (e.g., FIG. 5A) configured to store the input data 596.

In some embodiments, the data processor 312 is configured to execute an operating system 504 (e.g., FIG. 5A) on a storage side and jointly with the host device 220. On the storage side, the operating system 504 further includes a storage-side kernel 510 e.g., FIG. 5A). The storage-side kernel 510 is configured to convert data between TCP/IP packets and PCIe packets. Further, in some embodiments, the host device 220 is configured to execute an operating system 504 (e.g., FIG. 5A) jointly with the computational storage device 240. The host device 220 further includes a host-side kernel 560 (e.g., FIG. 5A). The operating system 504 further includes a relay application 558 (e.g., FIG. 5A) configured to relay TCP/IP packets according to the PCIe interface standard on a host side.

In some embodiments, the data processor 312 is configured to couple to a virtual communication link (e.g., 582 of FIG. 5A, 584 of FIG. 5B) that is configured to bidirectionally transfer TCP/IP packets according to a TCP/IP addressing protocol.

In some embodiments, the data processor 312 is configured to communicatively couple to a cluster of processors (e.g., 312-2, 312-2, 312-3, . . ., 312-k of FIG. 5B) of external devices distinct from the memory device (e.g., 312-1 of FIG. 5B). Each of the cluster of processors has a respective IP address. The data processor (e.g., 312-1 of FIG. 5B) is further configured to send and receive TCP/IP packets with each processor of the cluster of processors (e.g., 312-2, 312-2, 312-3, . . ., 312-k of FIG. 5B).

In some embodiments, the data processor 312 is configured to operate according to a notification mechanism including at least one of interrupt, polling, or doorbell.

In some embodiments, the data bus 580 is configured to communicate data according to a PCIe interface standard, and does not include an ethernet cable.

In accordance with some embodiments, a memory device 240 (e.g., FIGS. 2 and 5A) includes an input/output data interface 540 (e.g., FIG. 5A) configured to couple to a data bus 580 (e.g., FIG. 5A) and communicate data via the data bus 580. The memory device 240 further includes a data processor 312 (e.g., FIGS. 3 and 5A) coupled to the input/output data interface 540. The data processor 312 has a device IP address. The data processor 312 is configured to generate first payload data 590 (e.g., FIG. 5A) having a TCP/IP packet format. The first payload data 590 includes at least one of the device IP address of the data processor 312 and a target IP address of a host device 220 (e.g., FIGS. 2 and 5A). The data processor 312 is also configured to convert the first payload data 590 to output data 592 (e.g., FIG. 5A) having a PCIe packet format. The data processor 312 is further configured to provide the output data 592 to the input/output data interface 540 for communicating the output data 592 via the data bus 580.

In accordance with some embodiments, a memory system includes a memory controller, a processor distinct from the memory controller, and a non-volatile memory coupled to the memory controller. The memory stores instructions configured for performing any of the methods described in the above embodiments.

In accordance with some embodiments, a non-transitory computer-readable storage medium stores instructions, which when executed by a memory system cause the memory system to perform any of the methods described in the above embodiments.

It should be understood that the particular order in which the operations in FIG. 10 have been described are merely exemplary and are not intended to indicate that the described order is the only order in which the operations could be performed. One of ordinary skill in the art would recognize various ways to providing computational storage devices as described herein. It is also noted that more details on the method of providing computational storage devices are explained above with reference to FIGS. 1-9. For brevity, these details are not repeated in the description herein.

Memory is also used to store instructions and data associated with the method of 1000, and includes high-speed random-access memory, such as SRAM, DDR DRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing the method of 1000. Alternatively, in some embodiments, the memory device implements the method of 1000 at least partially based on an ASIC. The memory device includes a computational storage device (e.g., an SSD configured with data processing capabilities) in a data center or a client device.

In some embodiments, data are processed in one or more processors of a host device (e.g., a computer, a server, etc.), while a memory device is applied to provide input data or store output data for the host device. Data communication between the host device and the memory device is based on a Peripheral Component Interconnect Express (PCIe) interface standard. Conversely, in some embodiments, the memory device is transformed to a computational storage device incorporating at least one computing element (e.g., the data processor). The computing element is configured to process internal computational workloads (e.g., data processing operations) locally on the memory device, while a memory controller of the memory device specializes in performing memory access functions and internal memory management functions. In some embodiments, computing elements of a memory device or a plurality of memory devices of a memory system process data with a coherent and uniform perspective of file systems, and follow a substantially consistent programming model. A common file system may be applied based on a network communication network, which operates with a TCP/IP or UDP link. In some embodiments, when it comes to a SSD based memory device, an SSD standard interface is used by the memory device to exchange data with a host device. The memory device includes one or more computing elements that are either embedded in, or coupled to, a memory controller. The one or more computing elements are indirectly coupled the host device via a memory controller and an SSD data interface (e.g., a PCIe data interface) of the memory device.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages be implemented in hardware, firmware, software or any combination thereof.

What is claimed is:

1. A memory device, comprising:
an input/output data interface configured to couple to a data bus and communicate data via the data bus; and
a data processor coupled to the input/output data interface, wherein the data processor has a device Internet Protocol (IP) address, wherein the data processor is configured to:
generate first payload data having a Transmission Control Protocol/Internet Protocol (TCP/IP) packet format, the first payload data including at least one of the device IP address of the data processor and a target IP address of a host device;
convert the first payload data to output data having a Peripheral Component Interconnect Express (PCIe) packet format; and
provide the output data to the input/output data interface for communicating the output data via the data bus.

2. The memory device of claim 1, wherein the data processor is configured to:
obtain input data having the PCIe packet format, the input data including the device IP address, wherein the input data is provided via the input/output data interface; and
convert the input data to second payload data having a TCP/IP package format.

3. The memory device of claim 1, wherein the data bus is configured to communicate data between the input/output data interface and the host device according to a PCIe interface standard.

4. The memory device of claim 1, further comprising:
a memory controller coupled to the input/output data interface and distinct from the data processor, wherein the memory controller is configured to send the output data to the host device via the input/output data interface.

5. The memory device of claim 4, further comprising:
a memory buffer coupled to the data processor and the memory controller, wherein:
the memory buffer includes a first buffer portion allocated to the data processor and a second buffer portion allocated to the memory controller, the first buffer portion configured to store the output data; and
the memory controller is configured to move the output data stored in the first buffer portion to the second buffer portion before sending the output data to the input/output data interface.

6. The memory device of claim 4, wherein:
the memory controller is configured to receive input data having the PCIe packet format from the input/output data interface, store the input data in a memory buffer, and send an incoming notification to the data processor.

7. The memory device of claim 6, wherein the data processor is configured to obtain the input data from the memory buffer and convert the input data to second payload data having the TCP/IP packet format, the second payload data including at least the device IP address.

8. The memory device of claim 6, wherein the memory buffer further includes an outgoing buffer portion configured to store the output data and a receiving buffer portion configured to store the input data.

9. The memory device of claim 4, further comprising:
a non-volatile memory coupled to the data processor and the memory controller and including a plurality of memory blocks, wherein a subset of the plurality of memory blocks is reserved for the data processor.

10. A method of creating a virtual communication link between computing elements, comprising:
at a memory device including an input/output data interface configured to couple to a data bus and communicate data via the data bus, and a data processor coupled to the input/output data interface, wherein the data processor has a device Internet Protocol (IP) address, by the data processor:
generating first payload data having a Transmission Control Protocol/Internet Protocol (TCP/IP) packet format, the first payload data including at least one of the device IP address of the data processor and a target IP address of a host device;
converting the first payload data to output data having a Peripheral Component Interconnect Express (PCIe) packet format; and
providing the output data to the input/output data interface for communicating the output data via the data bus.

11. The method of claim 10, further comprising:
executing an operating system by the data processor, wherein the operating system further includes a storage-side kernel; and
converting data between TCP/IP packets and PCIe packets by the storage-side kernel.

12. The method of claim 11, further comprising:
executing the operating system by the host device on a host side, wherein the host device further includes a host-side kernel, and the operating system further includes a relay application; and
relaying TCP/IP packets according to a PCIe interface standard on the host side.

13. The method of claim 10, wherein the data processor is coupled to a virtual link, the method further comprising:
bidirectionally transferring TCP/IP packets by the virtual link according to a TCP/IP addressing protocol.

14. The method of claim 10, wherein the data processor is communicatively coupled to a cluster of processors of external devices distinct from the memory device, and each of the cluster of processors has a respective IP address, the method further comprising:
at the data processor, exchanging TCP/IP packets with each processor of the cluster of processors.

15. The method of claim 10, further comprising:
at the data processor, operating according to a notification mechanism including at least one of interrupt, polling, or doorbell.

16. The method of claim 10, further comprising:
at the data bus, communicating data according to a PCIe interface standard without using an ethernet cable.

17. The method of claim 10, further comprising, at the data processor:
obtaining input data having the PCIe packet format, the input data including the device IP address, wherein the input data is provided via the input/output data interface; and
converting the input data to second payload data having a TCP/IP package format.

18. The method of claim 10, further comprising communicating data between the input/output data interface and the host device by the data bus according to a PCIe interface standard.

19. The method of claim 10, wherein a memory controller is coupled to the input/output data interface and distinct from the data processor, the method further comprising:
send the output data by the memory controller to the host device via the input/output data interface.

20. A non-transitory computer-readable storage medium, having instructions stored thereon, which when executed by a memory device cause the memory system to:
at a data processor of the memory device, wherein the memory device includes an input/output data interface configured to couple to a data bus and communicate data via the data bus, and the data processor is coupled to the input/output data interface and has a device Internet Protocol (IP) address:
generate first payload data having a Transmission Control Protocol/Internet Protocol (TCP/IP) packet format, the first payload data including at least one of the device IP address of the data processor and a target IP address of a host device;
convert the first payload data to output data having a Peripheral Component Interconnect Express (PCIe) packet format; and
provide the output data to the input/output data interface for communicating the output data via the data bus.
